(19) United States
(12) Patent Application Publication
(10) Pub. No.: US 2026/0297355 A1
(43) Pub. Date: Oct. 1, 2026

(54) Recording Apparatus And Recording Method

(71) Applicant: SEIKO EPSON CORPORATION, Tokyo (JP)

(72) Inventors: Jun ITO, Shimosuwa (JP); Kentaro HARA, Shiojiri (JP); Sena GOZU, Shiojiri (JP)

(21) Appl. No.: 19/576,501

(22) Filed: Mar. 24, 2026

(30) Foreign Application Priority Data
Mar. 25, 2025 (JP) 2025-049337

(51) Int. Cl. C09D 11/38; B41J 2/175

(52) U.S. Cl. CPC C09D 11/38; B41J 2/175

(57) ABSTRACT

A recording apparatus includes an ink container, an ink supply path, an ink jet head, and an ink composition, in which the ink container includes an ink filling port through which the ink composition is poured, the ink jet head receives a supply of the ink composition from the ink container through the ink supply path and ejects the ink composition, and the ink composition an aqueous ink containing a pigment, an acetylene glycol-based surfactant, a 6- to 8-membered ring lactam, a solvent containing water, and a water-soluble urethane resin dissolved in the solvent.

### CROSS-REFERENCE TO RELATED APPLICATIONS

The present application is based on, and claims priority from JP Application Serial Number 2025-049337, filed Mar. 25, 2025, the disclosure of which is hereby incorporated by reference herein in its entirety.

### BACKGROUND

### 1. Technical Field

The present disclosure relates to a recording apparatus and a recording method.

### 2. Related Art

An ink jet recording apparatus that records an image or the like on a recording medium with minute ink droplets ejected from a nozzle of a recording head for ink jet recording has been known.

The ink jet recording apparatus has an ink container (for example, an ink cartridge) for supplying an ink composition to the recording head.

As such an ink container, for example, a type in which the ink container itself is replaced (so-called ink cartridge) when an amount of the ink composition in the ink container is equal to or less than a certain amount, and a type in which a continuous supply type ink container is replenished with the ink composition without replacing the ink container (so-called continuous supply type ink container) are known.

For example, JP-A-2020-100758 discloses an ink composition containing a self-dispersing pigment, a soap-free resin, and water, wherein the height of bubbles from the liquid surface 60 seconds after weighing 15 mg of the ink composition in a 50 ml sample bottle and shaking the sample bottle 100 times per minute is equal to or less than 1 cm, for the purpose of providing an ink composition in which foaming is suppressed and which is suitable for an ink jet recording apparatus provided with such a large-capacity ink storage container.

However, in JP-A-2020-100758, although suppression of foaming is described, transfer resistance is not studied, and a problem newly arising when transfer resistance is considered is not studied.

### SUMMARY

The present disclosure is as follows.

A recording apparatus of the present disclosure includes an ink container, an ink supply path, an ink jet head, and an ink composition, in which the ink container includes an ink filling port through which the ink composition is poured, the ink jet head receives a supply of the ink composition from the ink container through the ink supply path and ejects the ink composition, and the ink composition contains a pigment, an acetylene glycol-based surfactant, a 6- to 8-membered ring lactam, a solvent containing water, and a water-soluble urethane resin dissolved in the solvent.

A recording method of the present disclosure uses the recording apparatus of the present disclosure, and includes a supplying step of supplying the ink composition poured into the ink container through the ink filling port from the ink container to the ink jet head through the ink supply path, and an attaching step of attaching the ink composition to a recording medium by ejecting the ink composition from the ink jet head.

### BRIEF DESCRIPTION OF THE DRAWINGS

FIG. 1 is a schematic view of an example of a recording apparatus of an embodiment.

FIG. 2 is a table showing results of Examples.

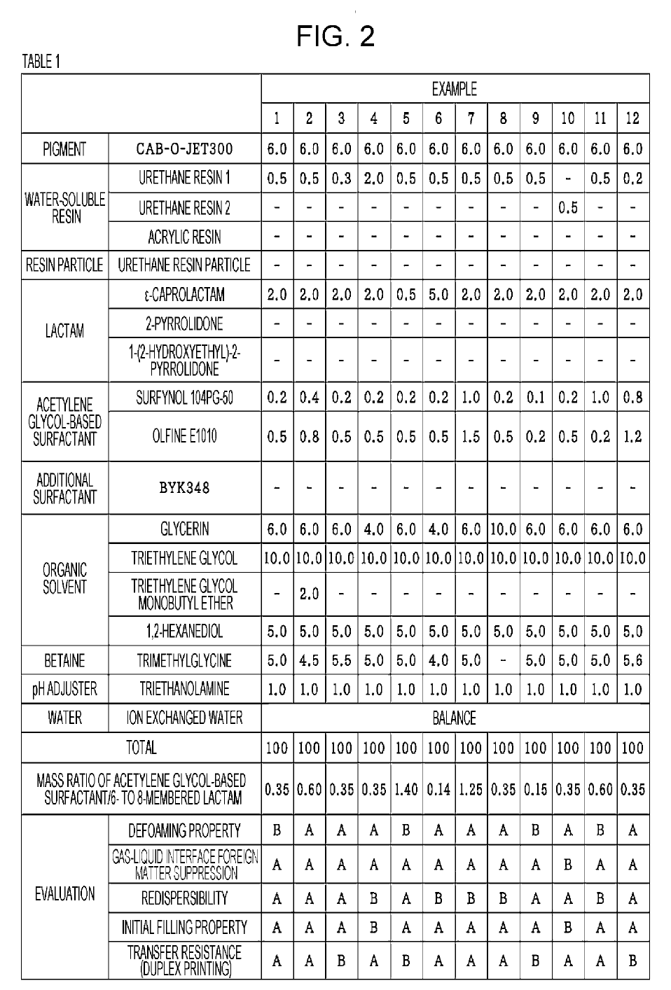

FIG. 3 is a table showing results of Comparative Examples.

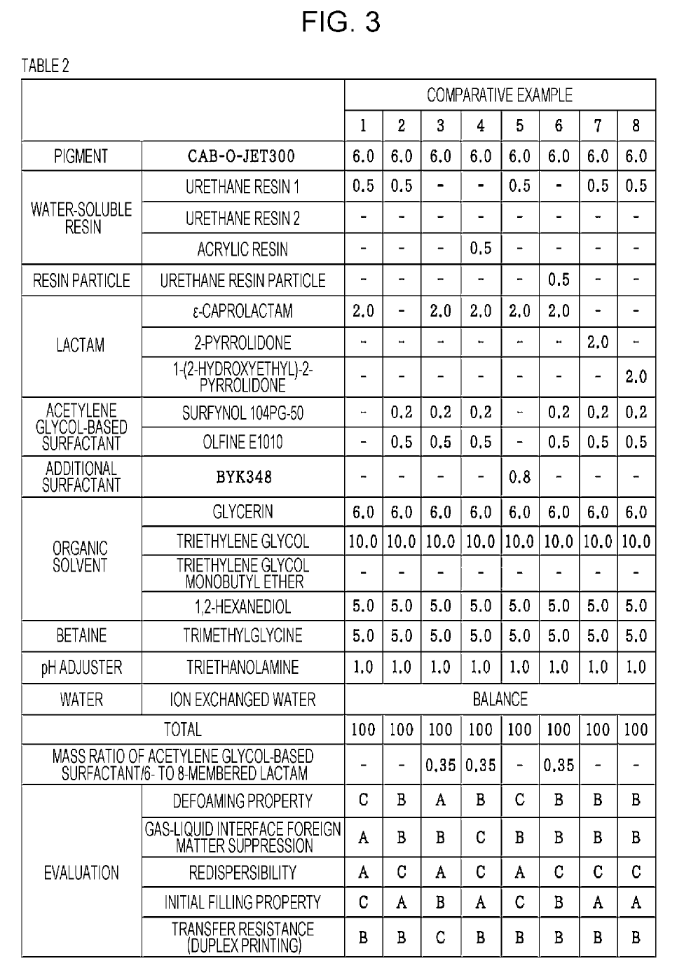

### DESCRIPTION OF EMBODIMENTS

An embodiment of the present disclosure (hereinafter, referred to as "the present embodiment") will be described in detail. However, the present disclosure is not limited thereto, and various modifications can be made without departing from the gist thereof. In the present specification, "to" used to indicate a numerical range represents "greater than or equal to" and "less than or equal to," with both numerical values before and after "to" included.

### 1. Recording apparatus

An ink jet recording apparatus (also simply referred to as the "recording apparatus") of the present embodiment includes an ink container, an ink supply path, an ink jet head, and an ink composition, in which the ink container includes an ink filling port through which the ink composition is poured, and the ink jet head receives a supply of the ink composition from the ink container through the ink supply path and ejects the ink composition. The ink composition is an aqueous ink containing a pigment, an acetylene glycol-based surfactant, a 6- to 8-membered ring lactam, a solvent containing water, and a water-soluble urethane resin dissolved in the solvent.

There has been a problem in that when printing is performed on plain paper or the like and ink of a recorded matter is rubbed, the ink is rubbed and peeled off. In addition, when a member in the recording apparatus rubs against a recording medium to which ink is attached, or when sheets of the recording media come into contact with each other, the ink is transferred to another member or another sheet of the recording medium, and thus the recording medium is contaminated in some cases. Such a phenomenon is called transfer contamination, and tends to occur particularly in a high-speed recording apparatus, for example, a line type ink jet printer. This is considered to be because, for example, in a high-speed recording apparatus, since the recording speed is high, a large number of discharged recording medium sheets are stacked in a short time, and accordingly, transfer of ink is likely to occur.

In order to solve this problem, it is considered that a fixing resin is added to ink to improve fixability of the pigment to paper, thereby suppressing occurrence of transfer contamination.

In recent years, a recording apparatus of a type in which an ink container is replenished with ink and used without using an ink cartridge has been widely used. Such a recording apparatus has an ink container provided with an ink filling port, and can perform high-volume continuous printing by replenishing the ink container with ink. Such a system is also referred to as a continuous ink supply system (CISS).

The CISS has an advantage that the frequency of ink replacement is significantly reduced as compared with a heretofore used cartridge system, and cost reduction and mass printing are enabled. On the other hand, in the CISS, a problem may arise due to drying of ink or generation of air bubbles in an ink container or the like. For example, when ink attached to a wall surface of the ink container is dried, the solid content thereof is less likely to be dispersed again, and the ink may become foreign matter. As a result, there is a possibility that the foreign matter passes through the ink flow path, reaches the ink jet head, enters the inside of the nozzle, and causes ejection failure. In addition, it has been confirmed that foreign matter is also generated on the liquid surface of the ink in the ink container, that is, on the gas-liquid interface, and the foreign matter causes ejection failure.

Further, when the ink container is replenished with the ink, bubbles are generated by the flow of the ink. If the bubbles reach the ink jet head without disappearing, normal ejection of the ink may be hindered. In particular, when an empty ink container is filled with the ink for the first time and the ink is supplied to the head to perform printing, ejection failure is likely to occur due to generation or remaining of the bubbles.

In order to solve these problems, in the present disclosure, the water-soluble urethane resin is contained as a fixing resin in the ink, and the acetylene glycol-based surfactant and the 6- to 8-membered ring lactam (hereinafter, also referred to as the "specific lactam") are used in combination, thereby achieving suppression of transfer contamination, suppression of generation of bubbles, suppression of generation of foreign matter at a gas-liquid interface, and the like while improving fixability and redispersibility of the ink.

Specifically, when the water-soluble urethane resin is contained in the ink, a film of the resin is formed on a surface of the ink, and the pigment can thus be prevented from peeling off. As a result, even before the ink is completely dried, ink transfer is suppressed, and a reduction in transfer contamination can be expected. In addition, since the resin easily forms a film on the surface of the ink coating film, fixability to paper is improved, and higher transfer resistance can be realized.

On the other hand, it has been generally considered that a water-soluble urethane resin is less likely to become foreign matter after drying as compared with a resin emulsion (resin particles), but when the ink is left in a tank for a long period of time in a CISS recording apparatus, the water-soluble urethane resin tends to become foreign matter. In addition, when the pigment and the water-soluble urethane resin are dried in combination, redispersibility is reduced, which may lead to generation of foreign matter at the gas-liquid interface.

Therefore, by adding the acetylene glycol-based surfactant to the ink, generation of bubbles can be suppressed, and the bubbles can be prevented from remaining in the head. As a result, a defoaming property is improved, and in particular, the ink can be stably supplied at the time of initial filling. However, since the acetylene glycol-based surfactant, in particular, an acetylene glycol-based surfactant having a low HLB value has low water solubility, the acetylene glycol-based surfactant is likely to become foreign matter when the ink is dried in a CISS tank, and in particular, a dried solid composite with the pigment is formed, which may cause a decrease in redispersibility of the pigment. In addition, when the pigment, the water-soluble urethane resin, and the acetylene glycol-based surfactant are dried in combination, the same problem may occur.

In order to solve such a problem, in the present disclosure, a specific lactam is added to the ink in addition to the acetylene glycol-based surfactant and the water-soluble urethane resin, thereby improving redispersibility and suppressing generation of foreign matter at the gas-liquid interface. The specific lactam has excellent moisture-retaining properties and have an effect of preventing ink components from drying and solidifying. Furthermore, even when the ink is dried and solidified, the inclusion of the specific lactam promotes collapse of dried solid matter and improves redispersibility. In addition, it is presumed that the ink is likely to maintain a wet state even in a dry state due to the action of the specific lactam.

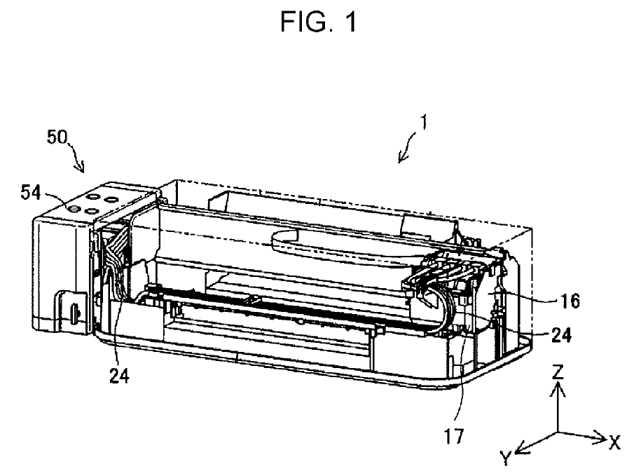

The recording apparatus of the present embodiment will be further described below with reference to the drawings. FIG. 1 is a perspective view schematically illustrating an example of a recording apparatus of the present embodiment. A recording apparatus 1 includes an ink container 50 and an ink supply path 24 that supplies ink from the ink container 50 to an ink jet head 17.

1. 1. Ink container

The ink container 50 has an ink filling port 54. The ink container is not particularly limited, and the following configuration may be specifically adopted. The ink container supplies the ink composition to the ink jet head. The ink container has an ink filling port provided in an upper portion, and the inside of the ink container may communicate with the outside air through the ink filling port. A user can insert a replenishment port of an ink bottle into the ink filling port of the ink container and pour the ink contained in the ink bottle into the ink container. That is, it is preferable that the ink container is preferably a so-called continuous supply type ink container which is replenished with the ink from the outside without replacing the ink container even when the ink contained in the ink container runs out. Since the problem of foaming in the ink composition often arises particularly at the time of refilling of the ink, it is preferable that the recording apparatus of the present embodiment have a continuous supply type ink container allowing refilling of the ink.

An ink jet printer including such a continuous supply type ink container allowing refilling of the ink may be used to print a character and an images on plain paper in an office, a SOHO, or the like.

The ink container 50 may have the ink filling port 54 for each ink. The ink filling port 54 is covered with a lid such as a cap (not shown) when the ink is not poured, and the lid can be opened and closed. The lid is opened, and the ink may be poured when pouring the ink.

The inside of the ink container 50 may be divided by a wall into a plurality of ink containers, or a plurality of ink containers may be arranged side by side. In this way, multiple ink containers are provided for each ink.

1. 2. Ink jet head

The ink jet head 17 ejects the ink composition supplied from the ink container 50. The ink jet head may have a nozzle surface provided at a position facing a recording surface of a recording medium, and eject the ink in a form of droplets from a plurality of nozzles provided on the nozzle surface to attach the ink to the recording surface of the recording medium.

As an ink jet recording method, for example, a method in which a strong electric field is applied between a nozzle and an acceleration electrode disposed in front of the nozzle, an ink is continuously ejected from the nozzle in a form of droplets, and a print information signal is imparted to a polarization electrode while ink droplets fly between deflection electrodes to perform printing; a method in which ink droplets are ejected in response to a printing information signal without deflecting the ink droplets (electrostatic attraction method); a method in which ink droplets are forcibly ejected by applying a pressure to an ink liquid with a small pump and mechanically vibrating a nozzle with a crystal oscillator or the like; a method in which a pressure and a printing information signal are simultaneously added to an ink with a piezoelectric element to eject ink droplets and perform recording (piezoelectric method); and a method in which an ink is heated and foamed using a microelectrode according to a printing information signal to eject ink droplets and perform recording (thermal jet method) can be used.

Further, the ink jet head 17 may be mounted on a carriage 16. The carriage 16 has the ink jet head 17 mounted thereon and reciprocated along the X axis by a carriage movement mechanism (not shown) including a motor, a timing belt, and the like. Along with such movement of the carriage 16, the ink jet head 17 is also reciprocated along the X-axis direction, whereby an image is recorded on the recording medium in the X-axis direction. In the present embodiment, a so-called serial head type ink jet recording apparatus is described as an example, but the present disclosure is not limited thereto, and the ink container according to the present disclosure can also be applied to a so-called line head type ink jet recording apparatus.

The recording medium can be transported by a paper feed mechanism (not shown) for feeding the recording medium in the Y-axis direction. An image can be recorded on the recording medium in the Y-axis direction by ejecting the ink from the ink jet head 17 in accordance with the movement of the recording medium by the paper feed mechanism.

1. 3. Ink composition

Components which may be included in the ink composition (hereinafter, also simply referred to as the "ink") in the embodiment will be described below. The ink composition is an aqueous ink containing a pigment, an acetylene glycol-based surfactant, a 6- to 8-membered ring lactam, a solvent containing water, and a water-soluble urethane resin dissolved in the solvent.

Each component of the ink composition of the present embodiment will be described in detail below.

1. 3. 1. Pigment

The ink composition in the present embodiment contains a pigment. Although the pigment is not particularly limited, examples thereof include inorganic pigments such as titanium oxide, iron oxide, calcium carbonate, barium sulfate, aluminum hydroxide, barium yellow, cadmium red, chrome yellow, carbon black, iron blue, and metal powder; and organic pigments such as quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments.

The pigment may be a self-dispersing pigment or a resin-dispersed pigment, and among these, a self-dispersing pigment is preferable. By using the self-dispersing pigment, the resin content in the ink can be reduced, and the defoaming property tends to be further improved.

Examples of the self-dispersing pigment include a pigment which can be dispersed in an aqueous solvent by directly or indirectly bonding a hydrophilic group (a carboxyl group, a sulfonic acid group, a phosphoric acid group, or the like) to the surface of the pigment by a physical treatment or a chemical treatment. Examples of the resin-dispersed pigment include a pigment in which a pigment is dispersed by a surfactant or a resin. The resin-dispersed pigment also includes a pigment coated with a resin.

As the self-dispersing pigments, commercially available products may be used, and examples thereof include CAB-O-JET300, 400, 450C, 465M, and 470Y (manufactured by Cabot Corporation).

The content of the pigment is preferably 0.5% to 20% by mass, 1% to 10% by mass, or 3% to 7% by mass with respect to the total amount of the ink composition.

1. 3. 2. Water-soluble urethane resin

Since the water-soluble urethane resin is easily formed into a film, transfer of the ink can be further suppressed.

The water-soluble urethane resin is a resin which is dissolved in water and does not include, for example, a dispersant resin which is attached to the surface of the pigment and is not dissolved in the ink or a resin which is present as resin particles.

By using such a water-soluble urethane resin, a smooth ink coating film is easily formed, and a transfer suppressing effect is further improved. Further, as compared with a water-insoluble resin such as resin particles, foreign matter is less likely to be generated at the gas-liquid interface, and foaming is less likely to occur.

The water-soluble urethane resin means a water-soluble urethane resin having a polar group in the molecular structure. The polar group may be in the form of a salt. Further, the polar group is preferably an acid group. Examples of the acid group include a carboxy group, a sulfonic acid group, and a phosphorus-containing group such as a phosphoric acid group.

The water-soluble urethane resin has a repeating unit derived from a polyisocyanate and a repeating unit derived from a polyol, and among these, a resin having a repeating unit derived from a polyol having an acid group is preferable, and a resin having repeating units respectively derived from a polyisocyanate, a polyol having no acid group, and a polyol having an acid group is preferable. The water-soluble urethane resin may further have a repeating unit derived from a polyamine.

The polyisocyanate means a compound having two or more isocyanate groups in the molecular structure thereof, and examples thereof include, but are not particularly limited to, an aliphatic polyisocyanate and an aromatic polyisocyanate.

The aliphatic polyisocyanate is not particularly limited, and examples thereof include polyisocyanates having a chain structure such as tetramethylene diisocyanate, dodecamethylene diisocyanate, hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate, and 3-methylpentane-1,5-diisocyanate; and polyisocyanates having a cyclic structure such as isophorone diisocyanate, hydrogenated xylylene diisocyanate, 4,4'-dicyclohexylmethane diisocyanate, 1,4-cyclohexane diisocyanate, methylcyclohexylene diisocyanate, and 1,3-bis(isocyanatomethyl) cyclohexane.

The aromatic polyisocyanate is not particularly limited, and examples thereof include tolylene diisocyanate, 2,2'-diphenylmethane diisocyanate, 2,4'-diphenylmethane diisocyanate, 4,4'-diphenylmethane diisocyanate, 4,4'-dibenzyl diisocyanate, 1,5-naphthylene diisocyanate, xylylene diisocyanate, 1,3-phenylene diisocyanate, 1,4-phenylene diisocyanate, dialkyldiphenylmethane diisocyanate, tetraalkyldiphenylmethane diisocyanate, and α,α,α',α'-tetramethylxylylene diisocyanate.

The polyol is a compound having two or more hydroxy groups in the molecular structure thereof. The polyol of the present embodiment is not particularly limited, and examples thereof include a polyol having no acid group and a polyol having an acid group.

The polyol having no acid group is not particularly limited, and examples thereof include a polyether polyol, a polyester polyol, and a polycarbonate polyol.

The polyether polyol is not particularly limited, and examples thereof include an addition polymer of an alkylene oxide and a polyol, and a glycol.

The alkylene oxide is not particularly limited, and examples thereof include ethylene oxide, propylene oxide, butylene oxide, and α-olefin oxide. Examples of the polyol to be subjected to addition polymerization with the alkylene oxide include diols such as 1,3-propanediol, 1,3-butanediol, 1,4-butanediol, 1,5-pentanediol, 1,6-hexanediol, 3-methyl-1,5-pentanediol, 2-butyl-2-ethyl-1,3-propanediol, 1,4-cyclohexanediol, 1,4-cyclohexanedimethanol, 4,4-dihydroxyphenylpropane, 4,4-dihydroxyphenylmethane, hydrogenated bisphenol A, and dimethylolurea and derivatives thereof; and triols such as glycerin, trimethylolpropane, 1,2,5-hexanetriol, 1,2,6-hexanetriol, pentaerythritol, trimethylol melamine and derivatives thereof, and polyoxypropylene triol.

Examples of the glycol include (poly)alkylene glycols such as tetramethylene glycol, hexamethylene glycol, ethylene glycol, diethylene glycol, triethylene glycol, tetraethylene glycol, polyethylene glycol, propylene glycol, dipropylene glycol, tripropylene glycol, polypropylene glycol, and (poly) tetramethylene glycol; and ethylene glycol-propylene glycol copolymers.

The polyester polyol is not particularly limited, and examples thereof include an acid ester. An acid component constituting the acid ester is not particularly limited, and examples thereof include aromatic dicarboxylic acids such as phthalic acid, naphthalenedicarboxylic acid, biphenyldicarboxylic acid, and tetrahydrophthalic acid; alicyclic dicarboxylic acids such as hydrogenated products of these aromatic dicarboxylic acids; and aliphatic dicarboxylic acids such as malonic acid, succinic acid, tartaric acid, oxalic acid, glutaric acid, adipic acid, pimelic acid, suberic acid, azelaic acid, sebacic acid, alkylsuccinic acid, linoleic acid, maleic acid, fumaric acid, mesaconic acid, citraconic acid, and itaconic acid. Anhydrides, salts, derivatives (alkyl esters and acid halides), and the like thereof can also be used as the acid component. A component that forms an ester with the acid component is not particularly limited, and examples thereof include polyols such as diols and triols; and glycols such as (poly) alkylene glycols. Examples of the polyols and glycols include those exemplified as the components constituting the polyether polyol described above.

The polycarbonate polyol is not particularly limited, and for example, a polycarbonate polyol produced by a known method can be used. Specific examples thereof include an alkanediol-based polycarbonate diol such as polyhexamethylene carbonate diol. Also included is a polycarbonate diol obtained by reacting a carbonate component such as an alkylene carbonate, a diaryl carbonate, or a dialkyl carbonate, or phosgene with an aliphatic diol component.

The polyol having an acid group is not particularly limited, and examples thereof include a polyol having an acid group such as a carboxylic acid group, a sulfonic acid group, a phosphoric acid group, and a phosphonic acid group. Among these, any one or more of a carboxy group, a sulfonic acid group, and a phosphorus-containing group such as a phosphoric acid group are preferable, and a carboxy group is more preferable.

The polyol having a carboxylic acid group is not particularly limited, and examples thereof include dimethylolacetic acid, dimethylolpropionic acid, dimethylolbutanoic acid, and dimethylolbutyric acid.

The acid group of the polyol having an acid group may be in a salt state. The cation forming such a salt is not particularly limited, and examples thereof include an alkali metal ion and a cation of an organic amine. The alkali metal ion is not particularly limited, and examples thereof include lithium, sodium, and potassium. The cation of the organic amine is not particularly limited, and examples thereof include an ammonium ion and dimethylamine.

The polyamine is not particularly limited, and examples thereof include monoamines having a plurality of hydroxy groups such as dimethylolethylamine, diethanolmethylamine, dipropanolethylamine, and dibutanolmethylamine; bifunctional polyamines such as ethylenediamine, propylenediamine, hexylenediamine, isophoronediamine, xylylenediamine, diphenylmethanediamine, hydrogenated diphenylmethanediamine, and hydrazine; and polyamines having three or more functional groups such as diethylenetriamine, triethylenetetramine, tetraethylenepentamine, polyamidepolyamine, and polyethylene polyimine.

The acid number of the water-soluble urethane resin is preferably 40 to 100 mg KOH/g, 40 to 90 mg KOH/g, 45 to 80 mg KOH/g, or 50 to 70 mg KOH/g. The acid number of the water-soluble urethane resin is not particularly limited, and can be adjusted by, for example, the amount of the polyol having an acid group used. In addition, as a method for measuring the acid number, a method described in Examples below can be used. When the acid number of the water-soluble urethane resin is within the above ranges, the suppression of foreign matter formation and the defoaming property tend to be more excellent.

The weight-average molecular weight of the water-soluble urethane resin is preferably 5,000 to 150,000, 10,000 to 100,000, 15,000 to 50,000, 20,000 to 30,000, or 20,000 to 23,000. The weight-average molecular weight of the water-soluble urethane resin is not particularly limited, and can be adjusted by, for example, the reaction temperature and the reaction time of the polyisocyanate and the polyol. In addition, as a method for measuring the weight average molecular weight, a method described in Examples below can be used.

The content of the water-soluble urethane resin is preferably 0.05% by mass or more, 0.1% to 5.0% by mass, 0.1% to 4.0% by mass, 0.1% to 3.0% by mass, 0.2% to 2.0% by mass, 0.3% to 1.0% by mass, or 0.4% to 0.8% by mass with respect to the total amount of the ink composition. When the content of the water-soluble urethane resin is in the above ranges, transfer suppression tends to be more excellent.

1. 3. 3. Surfactant

The ink composition in the present embodiment contains a surfactant. The surfactant can reduce the surface tension of the ink composition and improve wettability with the recording medium. The surfactant is not particularly limited, and for example, an acetylene glycol-based surfactant, a silicone-based surfactant, a fluorine-based surfactant, or a polyoxyethylene alkyl ether-based surfactant can be used.

The silicone-based surfactant is not particularly limited and preferable examples thereof include a polysiloxane-based compound. The polysiloxane-based compound is not particularly limited and examples thereof include a polyether-modified organosiloxane.

The fluorine-based surfactant is not particularly limited, and examples thereof include perfluoroalkyl sulfonic acid salts, perfluoroalkyl carboxylic acid salts, perfluoroalkyl phosphoric acid esters, perfluoroalkyl ethylene oxide adducts, perfluoroalkyl betaines, and perfluoroalkylamine oxide compounds.

The polyoxyethylene alkyl ether-based surfactant is not particularly limited and may be appropriately selected depending on the intended purpose. Those selected from compounds represented by general formula, CₙHₙ₊₁O(CₘH₂ₘO)ₗH (where, in the general formula, n is an integer of 5 or more, m and l each represent an integer of 1 or more) are preferable, for example, and specific examples thereof include C₈H₁₇O(C₂H₄O)₂H, C₁₀H₂₁O(C₂H₄O)₄H, C₁₂H₂₅O(C₂H₄O)₃H, C₁₂H₂₅O(C₂H₄O)₇H, C₁₂H₂₅O(C₂H₄O)₁₂H, C₁₃H₂₇O(C₂H₄O)₃H, C₁₃H₂₇O(C₂H₄O)₅H, C₁₃H₂₇O(C₂H₄O)₇H, C₁₃H₂₇O(C₂H₄O)₉H, C₁₃H₂₇O(C₂H₄O)₁₂H, C₁₃H₂₇O(C₂H₄O)₂₀H, C₁₃H₂₇O(C₂H₄O)₃₀H, and C₁₄H₂₉O(C₂H₄O)₃₀H.

Among the surfactants described above, an acetylene glycol-based surfactant which is excellent in ink permeability into plain paper which is one of recording media is preferable. As the acetylene glycol-based surfactant, the above-described acetylene glycol-based surfactant may be used. It should be noted that the silicone surfactant rather tends to foam, and thus is not excellent in the defoaming property.

1. 3. 3. 1. Acetylene glycol-based surfactant

When the acetylene glycol-based surfactant is contained, the defoaming property is further improved, and an initial filling property is also excellent. As a result, when the ink is additionally poured into the CISS tank or when the CISS tank is initially filled with the ink, the ejection failure due to remaining bubbles which are generated when the ink is poured vigorously can be suppressed.

The acetylene glycol-based surfactant is not particularly limited, and examples thereof include alkyleneoxide adducts of 2,4,7,9-tetramethyl-5-decyne-4,7-diol and 2,4,7,9-tetramethyl-5-decyne-4,7-diol, and alkyleneoxide adducts of 2,4-dimethyl-5-decyne-4-ol and 2,4-dimethyl-5-decyne-4-ol. Commercially available products of such acetylene glycol-based surfactants are not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, and GA (all of the above are trade names, manufactured by Air Products and Chemicals, Inc.), OLFINE B, Y, P, A, STG, SPC, E1004, E1010, PD-001, PD-002W, PD-003, PD-004, EXP. 4001, EXP. 4036, EXP. 4051, EXP. 4300, AF-103, AF-104, AK-02, SK-14, and AE-3 (all of the above are trade names, manufactured by Nissin Chemical Industry Co., Ltd), and Acetylenol E00, E00P, E40, and E100 (all of the above are trade names, manufactured by Kawaken Fine Chemicals Co., Ltd).

Among these, the acetylene glycol-based surfactant preferably includes an acetylene glycol-based surfactant having an HLB value of 6 or less, and may include an acetylene glycol-based surfactant having an HLB value of more than 6. The acetylene glycol-based surfactant having an HLB value of more than 6 is more excellent in the defoaming property, and on the other hand, the acetylene glycol-based surfactant having an HLB value of 6 or less improves ink permeability into the recording medium, and thus an unpermeated ink composition is less likely to remain. In this manner, contamination of a transport path due to the unpermeated ink composition, transfer of the contamination of the transport path to another recording medium, and deterioration in a transport property can be suppressed.

The HLB value of the acetylene glycol-based surfactant having a low HLB value is 6 or less, preferably 5 or less, and more preferably 4 or less. When the HLB value is 6 or less, the permeability of the ink composition tends to be further improved. The lower limit of the HLB value is preferably 0 or more, 1 or more, or 2 or more.

Here, the HLB value is a value representing the balance between hydrophobicity and hydrophilicity of the surfactant, and the smaller the HLB value, the more hydrophobic the surfactant, and the larger the HLB value, the more hydrophilic the surfactant. In the present disclosure, the HLB value is calculated by the Griffin method.

Examples of a specific structure of the acetylene glycol-based surfactant having an HLB value of 6 or less include 2,4,7,9-tetramethyl-5-decyne-4,7-diol and alkylene oxide adducts thereof, with the number of moles of an alkylene oxide added in each adduct being 15 or less, 9 or less, or 8 or less.

The content A of the acetylene glycol-based surfactant having an HLB value of 6 or less is preferably 0.1% by mass or more, 0.2% by mass or more, or 0.25% by mass or more with respect to the total amount of the ink composition. When the content A of the acetylene glycol-based surfactant having an HLB value of 6 or less is 0.1% by mass or more, permeability tends to be improved, and transfer evaluation tends to be good. In addition, the content A of the acetylene glycol-based surfactant having an HLB value of 6 or less is preferably 1.0% by mass or less, 0.8% by mass or less, 0.6% by mass or less, or 0.4% by mass or less with respect to the total amount of the ink composition.

The HLB value of the acetylene glycol-based surfactant having a high HLB value is more than 6, preferably 7 or more, or 8 or more. When the lower limit of the HLB value is within the above range, the defoaming property tends to be further improved. The upper limit of the HLB value is preferably 16 or less, 15 or less, or 14 or less.

Examples of a specific structure of the acetylene glycol-based surfactant having an HLB value of more than 6 is not particularly limited, and examples thereof include 5,8-dimethyl-6-dodecyne-5,8-diol and alkylene oxide adducts thereof, 4,7-dimethyl-5-decyne-4,7-diol or alkylene oxide adducts thereof, and alkylene oxide adducts of 2,4,7,9-tetramethyl-5-decyne-4,7-diol, with the number of moles of an alkylene oxide added in each adduct being 9 or more, 10 or more, or 16 or more.

The content of the acetylene glycol-based surfactant having an HLB value of more than 6 is preferably 1.5% by mass or less, 1% by mass or less, 0.8% by mass or less, or 0.5% by mass or less with respect to the total amount of the ink composition. In addition, the content of the acetylene glycol-based surfactant having an HLB value of more than 6 is preferably 0.1% by mass or more, 0.2% by mass or more, or 0.3% by mass or more with respect to the total amount of the ink composition.

In addition, the ratio (mass ratio) of the content of the acetylene glycol-based surfactant having an HLB value more than 6 to the content of the acetylene glycol-based surfactant having an HLB value of 6 or less is preferably 0.1 to 5.0, 0.1 to 3.0, or 0.2 to 2.5.

In the present embodiment, the content of the acetylene glycol-based surfactant is preferably 0.1% by mass or more, 0.2% to 2.5% by mass, 0.4% to 1.2% by mass, or 0.5% to 0.8% by mass with respect to the total amount of the ink composition.

The ratio (mass ratio) of the content of the water-soluble urethane resin to the content of the acetylene glycol-based surfactant is preferably 0.05 to 7.0, 0.1 to 5.0, 0.1 to 3.0, 0.2 to 1.7, or 0.4 to 1.0.

1. 3. 4. Lactam

The ink composition of the present embodiment contains a 6- to 8-membered ring lactam. Such a lactam is excellent in moisture retention and can prevent ink components from being dried and solidified. Further, there is also an effect of suppressing generation of foreign matter at the gas-liquid interface. In addition, in the case where the lactam is included, even when the ink composition is dried and solidified, redispersibility is excellent. Although the mechanism is not limited, it is presumed that the inclusion of the specific lactam provides an effect of facilitating loosening of a dried and solidified product of the ink composition, and the specific lactam can maintain a wet state even after the ink composition is dried.

In the related art, it has been considered that the water-soluble urethane resin also provides an effect of preventing the acetylene glycol-based surfactant from becoming foreign matter. However, under a condition in which drying of the ink progresses in the CISS tank, formation of foreign matter and deterioration of redispersibility are improved by the inclusion of the lactams. The lactam provides an effect of preventing the water-soluble urethane resin from becoming foreign matter the formation of foreign matter and an effect of redispersing the solid content including the pigment, and also provides an effect of preventing the acetylene glycol-based surfactant from becoming foreign matter. Further, the lactam also provides an effect of assisting water solubility of the acetylene glycol-based surfactant, suppressing formation of gas-liquid interface foreign matter, and enhancing redispersibility.

The lactam means a compound having a structure in which a carboxy group and an amino group in the molecule are dehydrated and condensed to form a ring.

The 6- to 8-membered ring lactam is not particularly limited, and examples thereof include ε-caprolactam and derivatives thereof. In the present embodiment, ε-caprolactam or a derivative thereof is preferably included, and ε-caprolactam is preferably included. Under a condition in which drying of the ink progresses in the CISS tank, from the viewpoint of suppressing formation of foreign matter and suppressing deterioration of redispersibility, ε-caprolactam and a derivative thereof are preferably included, and ε-caprolactam is preferably included.

The content of the 6- to 8-membered ring lactam is not particularly limited, and is preferably 0.1% to 10% by mass, 0.5% to 5.0% by mass, or 1.0% to 3.0 by mass with respect to the total amount of the ink composition.

In the present embodiment, the mass ratio between the lactam and the acetylene glycol-based surfactant is preferably in a predetermined range. The mass ratio A/B of the content A of the acetylene glycol-based surfactant to the content B of the 6- to 8-membered ring lactam is preferably 0.1 to 2.0, 0.1 to 1.5, or 0.2 to 1.0.

1. 3. 5. Solvent

1. 3. 5. 1. Water

In the aqueous ink composition of the present embodiment, a main solvent component is water. The water contained in the ink composition of the present embodiment is not particularly limited, and examples thereof include ion exchanged water, ultrafiltration water, reverse osmosis water, and distilled water.

The content of water is preferably 50.0% by mass or more, 50.0% to 98.0% by mass, 52.5% to 72.5% by mass, 55% to 70% by mass, 57.5% to 67.5% by mass, or 60% to 65% by mass with respect to the total amount of the ink composition.

1. 3. 5. 2. Organic solvent

The ink composition according to the present embodiment may contain an organic solvent.

Examples of the organic solvent include an alkanediol, a polyhydric alcohol, and a glycol ether. One type of these solvents may be used alone, or a mixture of two or more types may be used.

Examples of the alkanediol include 1,2-alkanediols having 4 to 8 carbon atoms (for example, 1,2-butanediol, 1,2-pentanediol, 1,2-hexanediol, and 1,2-octanediol), 2-methyl-1,3-propanediol, 2,2-dimethyl-1,3-propanediol, and 2-ethyl-1,3-hexanediol.

The alkanediol has a function of improving the wettability with respect to the recording medium and suppressing drying and solidification of the ink on the nozzle surface of the recording head.

When the alkanediol is contained, the content thereof may be set to, for example, 0.1% to 20% by mass with respect to the total amount of the ink composition. In order to prevent wettability from being excessively improved, the content is preferably 0.5% to 5% by mass.

Among the alkanediols described above, a 1,2-alkanediol having 5 or 6 carbon atoms is preferably used. This is because such a compound is less likely to decrease the surface tension of the ink despite improvement in permeability and wettability of the ink with respect to the recording medium.

Examples of the glycol ether include an alkylene glycol monoether and an alkylene glycol diether.

Examples of the alkylene glycol monoether include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, and dipropylene glycol monoethyl ether.

Examples of the alkylene glycol diether include ethylene glycol dimethyl ether, ethylene glycol diethyl ether, ethylene glycol dibutyl ether, diethylene glycol dimethyl ether, diethylene glycol diethyl ether, diethylene glycol ethyl methyl ether, diethylene glycol dibutyl ether, triethylene glycol dimethyl ether, triethylene glycol diethyl ether, triethylene glycol dibutyl ether, triethylene glycol butyl methyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

One type of the glycol ether may be used alone, or a mixture of two or more types may be used. The glycol ether can be preferably used because the surface tension of the ink is less likely to decrease despite the improvement in permeability and wettability of the ink with respect to the recording medium.

When the glycol ether is contained, the content thereof may be set to, for example, 0.05% to 6% by mass with respect to the total amount of the ink composition. Furthermore, the content is preferably 0.2% to 4% by mass in order to appropriately control wettability in consideration of precipitation of aggregates and the like.

Examples of the polyhydric alcohol (excluding the alkanediols) include ethylene glycol, propylene glycol, 1,3-propanediol, 1,3-butanediol, 1,3-pentanediol, 1,4-butanediol, 1,5-pentanediol, 1,6-hexanediol, 2,3-butanediol, 3-methyl-1,3-butanediol, 2-methyl-2,4-pentanediol, 3-methyl-1,5-pentanediol, diethylene glycol, triethylene glycol, tetraethylene glycol, dipropylene glycol, trimethylolpropane, and glycerin. The polyhydric alcohol can be preferably used from the viewpoint of suppressing the drying and solidification of the ink on the nozzle surface of the head to reduce clogging, ejection failure, and the like. When the polyhydric alcohol is contained, the content thereof may be, for example, 5% by mass or more, and further 5% to 30% by mass with respect to the total amount of the ink composition.

The polyhydric alcohol may function as a moisturizing agent. Among the above, by using glycerin and one or more selected from polyhydric alcohols (except for glycerin among the polyhydric alcohols described above) in combination, it is possible to effectively suppress both long-term moisture evaporation and moisture evaporation which rapidly occurs on a wall surface of an ink chamber. In this case, more preferable polyhydric alcohols are propylene glycol, dipropylene glycol, 1,3-butanediol, diethylene glycol, triethylene glycol, trimethylolpropane, and triethylene glycol.

In a case where the ink of the present embodiment contains any one or more selected from 1,2-alkanediols having 4 to 8 carbon atoms, 2-methyl-1,3-propanediol, 2,2-dimethyl-1,3-propanediol, and 2-ethyl-1,3-hexanediol, and glycol ether, it is desirable to add a moisturizing agent in which glycerin and one or more selected from other polyhydric alcohols (except for glycerin among the polyhydric alcohols described above) are used in combination, from the viewpoint of preventing precipitation of aggregates.

The total content of the organic solvent is preferably 0.1% to 30% by mass, 1.0% to 25% by mass, or 5% to 25% by mass with respect to the total amount of the ink composition.

1. 3. 6. Betaine

When the ink composition contains a betaine, redispersibility tends to be excellent. Although the mechanism is not limited, it is considered that a state in which the betaine takes in the water-soluble urethane resin is formed, and it can be presumed that even when foreign matter is formed, redispersibility is provided.

The term "betaine" refers to a compound having a positive charge and a negative charge at non-adjacent positions in the same molecule, in which a hydrogen atom capable of dissociating is not bonded to the atom having the positive charge, constituting an intramolecular salt, and the compound is not charged as a whole molecule. In the present embodiment, the betaine preferably has a quaternary ammonium cation as the positively charged moiety.

The betaine is not particularly limited, and examples thereof include trimethylglycine, γ-butyrobetaine, homarine, trigonelline, carnitine, homoserine betaine, valine betaine, lysine betaine, ornithine betaine, alanine betaine, stachydrine, and glutamic acid betaine. Among these, it is preferable to contain any one or more of trimethylglycine, γ-butyrobetaine, and carnitine, and it is more preferable to contain trimethylglycine. Accordingly, redispersibility tends to be further improved. It is noted that one type of the betaine may be used alone, or two or more types may be used in combination.

The number of carbon atoms constituting the betaine is preferably 4 to 12, 4 to 7, or 4 to 6. When the number of carbon atoms of the betaine is within the above ranges, stability against contamination of chargeable foreign matter or the like tends to be further improved.

The content of betaine is preferably 1.0% by mass or more, 3.0% to 13% by mass, 4.0% to 10% by mass, 4.0% to 8.0% by mass, or 4.0% to 6.0% by mass with respect to the total amount of the ink composition.

1. 3. 7. pH adjuster

The ink composition of the present embodiment may contain a pH adjuster. The pH adjuster is not particularly limited, and examples thereof include an organic base and an inorganic base. The organic base is not particularly limited, and examples thereof include triethanolamine, diethanolamine, monoethanolamine, and tripropanolamine. The inorganic base is not particularly limited, and examples thereof include lithium hydroxide, sodium hydroxide, and potassium hydroxide.

The content of the pH adjuster is preferably 0.01% to 3.0% by mass, 0.01% to 2.0% by mass, 0.03% to 1.5% by mass, and 0.05% to 1.0% by mass with respect to the total amount of the ink composition.

1. 3. 8. Other components

The ink composition according to the present embodiment may contain, in addition to the above-described components, other publicly known components that can be used in the ink composition in the related art. The other components are not particularly limited, and examples thereof include a dissolution aid, a viscosity modifier, an antioxidant, a preservative, a corrosion inhibitor, a chelating agent and other additives for capturing certain metal ions that affect dispersion, and an organic solvent other than those described above. One type of the other components may be used alone, or two or more types may be used in combination.

### 2. Recording medium

The recording apparatus described in the present embodiment may be used for recording on a recording medium. The recording medium used in the recording apparatus according to the present embodiment is not particularly limited, and examples thereof include an absorptive recording medium, a low-absorptive recording medium, and a non-absorptive recording medium, and the absorptive recording medium is preferably used.

The absorptive recording medium is not particularly limited, and examples thereof include plain paper such as electrophotographic paper having high ink permeability, and ink jet paper (ink jet paper including an ink absorbing layer formed of silica particles or alumina particles, or an ink absorbing layer formed of a hydrophilic polymer such as polyvinyl alcohol (PVA) or polyvinyl pyrrolidone (PVP)). Fabric is also included.

A preferable absorptive recording medium in the present embodiment is plain paper.

The low-absorptive recording medium is not particularly limited, and examples thereof include art paper, coated paper, cast paper, and the like, which have relatively low ink permeability and are used in general offset printing.

The non-absorptive recording medium is not particularly limited, and examples thereof include films and plates of plastic such as polyvinyl chloride, polyethylene, polypropylene, polyethylene terephthalate (PET), polycarbonate, polystyrene, and polyurethane; plates of metal such as iron, silver, copper, and aluminum; metal plates produced through vapor deposition of such various kinds of metal, plastic films, and plates of alloy such as stainless steel and brass; and recording media in which a film of plastic such as polyvinyl chloride, polyethylene, polypropylene, polyethylene terephthalate (PET), polycarbonate, polystyrene, or polyurethane is adhered to (coats) a paper base material.

Here, the term "absorptive recording medium" refers to a recording medium in which the amount of water absorption from the start of contact to 30 msec in the Bristow's method exceeds 10 mL/m². The Bristow's method is the most popular method as a method of measuring a liquid absorption amount in a short time, and is also employed by the Japan Technical Association of the Pulp and Paper Industry (JAPAN TAPPI). Details of the test method are described in "method for determining the liquid absorbability of paper and board (Bristow's method)" of standard No. 51 of "JAPAN TAPPI Paper and Pulp Test Method 2000 Edition."

### 3. Recording method

The recording method of the present embodiment is a recording method using the recording apparatus of the present embodiment, and includes a supplying step of supplying the ink composition poured into the ink container through the ink filling port from the ink container to the ink jet head through the ink supply path, and an attaching step of ejecting the ink composition from the ink jet head and attaching the ink composition to the recording medium.

In addition, the recording method of the present embodiment may include a step of pouring the ink into the ink container. This step is a step of opening the lid of the ink filling port of the ink container, pouring the ink into the ink container through the ink filling port, and replenishing the ink container with the ink. For example, the ink contained in an ink bottle or the like need only be poured from the ink bottle into the ink filling port.

The supplying step is a step of supplying the ink composition poured into the ink container through the ink filling port from the ink container to the ink jet head through the ink supply path. The configuration of supplying the ink composition from a container to the ink jet head is not particularly limited, and for example, the ink composition may be sent by a pump or the like formed in the ink supply path.

The attaching step is a step of ejecting the ink composition from the ink jet head to attach the ink composition to the recording medium. As described above, examples of the ink jet method include a charge deflection method, a continuous method, and an on-demand method (a piezoelectric method or a bubble jet (registered trademark) method).

### Examples

The present disclosure will be described in more detail with reference to Examples and Comparative Examples below. The present disclosure is not limited by Examples below in any way.

1. Preparation of ink jet composition

The ink jet ink compositions of Examples and Comparative Examples are obtained by putting the respective components into a mixture tank so as to achieve the compositions described in Tables 1 and 2, mixing and stirring the same, and further filtering same through a membrane filter. Unless otherwise specified, numerical values for the respective components shown in each example in the tables indicate mass%. In addition, the content (mass%) of each of the pigment, the water-soluble resin, and the resin particle in Tables 1 and 2 indicates the solid content concentration.

The materials shown in Tables 1 and 2 are as follows.

### Pigment

CAB-O-JET300 (manufactured by Cabot Corporation, solid content: 15%)

Water-soluble resin

Water-soluble urethane resin

Water-soluble urethane resin 1:

Water-soluble urethane resin 1 is prepared by the following method.

First, a four-neck flask equipped with a stirrer, a thermometer, a nitrogen gas inlet tube, and a reflux tube is prepared. In the four-neck flask, 41.7 parts by weight of isophorone diisocyanate, 40.1 parts by weight of polypropylene glycol (number average molecular weight: 2,000), 13.2 parts by weight of dimethylolpropionic acid, and 200.0 parts by weight of methyl ethyl ketone are placed, and the mixture is reacted at 80°C for 6 hours in a nitrogen gas atmosphere (primary reaction). Then 0.6 parts by weight of ethylenediamine, 2.0 parts by weight of methanol, 2.4 parts by weight of dimethylolpropionic acid, and 100.0 parts by weight of methyl ethyl ketone are added. The residual ratio of isocyanate groups is confirmed with FT-IR, and reaction is performed at 80°C until a desired residual ratio is obtained (secondary reaction) to obtain a reaction liquid. The resulting reaction solution is cooled to 40°C, ion exchanged water is then added, and an aqueous potassium hydroxide solution is added while stirring at a high speed with a homomixer. Methyl ethyl ketone is distilled off from the obtained liquid by heating under reduced pressure to obtain a liquid containing water-soluble urethane resin 1.

With respect to water-soluble urethane resin 1 obtained, hydrochloric acid is added to a liquid containing water-soluble urethane resin 1 to precipitate the water-soluble urethane resin, and then the resin is vacuum-dried at 40°C overnight and dissolved in tetrahydrofuran to prepare a sample. The acid number of water-soluble urethane resin 1 is measured by potentiometric titration using a potassium hydroxide-methanol titrant, and the acid number is 65 mg KOH/g.

The weight average molecular weight of the urethane resin of water-soluble urethane resin 1 obtained is about 21000 in terms of polystyrene as measured by gel permeation chromatography (GPC).

Water-soluble urethane resin 2:

Water-soluble urethane resin 2 is prepared in the same manner as in the preparation of water-soluble urethane resin 1 except that the addition amount of polypropylene glycol is decreased and the addition amount of dimethylolpropionic acid in the primary reaction and the secondary reaction is increased in the preparation of water-soluble urethane resin 1. In addition, the acid number and the weight-average molecular weight of water-soluble urethane resins 2 are measured by the same measurement methods as those for water-soluble urethane resin 1. As a result, the acid number is 75 mg KOH/g, and the weight-average molecular weight is about 21000.

Additional resin

Water-soluble acrylic resin

A water-soluble acrylic resin is prepared by the following method.

A four-neck flask equipped with a stirrer, a thermometer, a reflux condenser, and a nitrogen gas inlet tube is prepared. In the four-neck flask, 200.0 parts by weight of ethylene glycol monobutyl ether is placed, and the temperature is raised to 130°C while stirring under a nitrogen gas atmosphere. To the four-neck flask, 62.0 parts by weight of a styrene monomer, 22.0 parts by weight of butyl acrylate, 16.0 parts by weight of acrylic acid, and 4.0 parts of a polymerization initiator (t-butyl peroxide) are added dropwise over 3 hours. After aging for 2 hours, ethylene glycol monobutyl ether is distilled off under reduced pressure to obtain a water-soluble acrylic resin.

### Resin particles

SUPERFLEX 420 (manufactured by DKS Co. Ltd., urethane-based resin emulsion)

### Lactam

### ε-Caprolactam (CPL)

2-Pyrrolidone

1-(2-Hydroxyethyl)-2-pyrrolidone

### Surfactant

Acetylene glycol-based surfactant

"SURFYNOL 104PG-50" manufactured by Air Products Japan, Inc., 2,4,7,9-tetramethyl-5-decyne-4,7-diol. The acetylene glycol-based surfactant has an HLB value of 4, and corresponds to the acetylene glycol-based surfactant "having an HLB value of 6 or less" in the present embodiment.

"OLFINE E1010" manufactured by Nissin Chemical Industry Co., Ltd. The acetylene glycol-based surfactant has an HLB value of 13 to 14, and corresponds to the acetylene glycol-based surfactant "having an HLB value of more than 6" in the present embodiment.

BYK348 (silicone-based surfactant manufactured by BYK Japan KK)

Organic solvent

glycerin

Triethylene glycol

Triethylene glycol monobutyl ether

1,2-Hexanediol

### Betaine

### Trimethylglycine

pH adjuster

### Triethanolamine

### Water

Ion exchanged water

2. Evaluation

2. 1. Defoaming property

Into a 110-ml screw-top bottle, 20 g of each of the ink compositions of Examples and Comparative Examples is put, and the bottle is capped and sealed. The screw-top bottle containing the ink is shaken with an amplitude of 10 cm at a rate of about 10 times per 5 seconds, and the state of defoaming until the liquid surface is seen is determined according to the following criteria.

Evaluation criteria
A: The liquid surface becomes visible within 3 minutes.
B: The liquid surface becomes visible within 5 minutes.
C: The liquid surface remains invisible even after 5 minutes.

When 100 ml of ink is poured into a CISS tank of a tester, ink with an inferior defoaming property tends to require a longer time for the foam generated to dissipate.

2. 2. Gas-liquid interface foreign matter suppression evaluation

A modified machine of an ink jet recording apparatus (EW-M634T manufactured by Seiko Epson Corporation) provided with a CISS tank is prepared, and 100 ml of the ink composition of each of Examples and Comparative Examples is poured into the main tank (CISS tank). The CISS tank is made of polypropylene.

Thereafter, the ink jet recording apparatus containing the ink composition is allowed to stand in an environment of 60°C for 5 days. After the standing, the ink in the CISS tank is extracted, foreign matter is collected, and determination is made based on the following criteria.

Evaluation criteria
A: No foreign matter (ink aggregate) is generated.
B: Generation of a small amount of foreign matter (ink aggregate) is observed.
C: Generation of a large amount of foreign matter (ink aggregate) is observed.

2. 3. Redispersibility

It is confirmed whether the ink composition once dried on the nozzle surface or the like is dissolved again when a new ink composition is added to the ink composition.

On a plate made of the same material (polypropylene, PP) as that of the CISS tank of the test machine, 2 μL of the ink composition is dropped and dried at 60°C for one day.

A fresh ink is added dropwise to the dried ink composition, and the ink is wiped off after standing for 3 minutes, and determination is made based on the following criteria.

Evaluation criteria
A: All ink droplets are dissolved again.
B: Although ink droplets are dissolved again, there is a residue of the dried ink composition on the PP plate.
C: The ink droplets are not dissolved again and remain solid on the PP plate.

2. 4. Initial filling property

A modified machine of an ink jet recording apparatus (EW-M634T manufactured by Seiko Epson Corporation) provided with a CISS tank is prepared, and the ink is poured into the main tank (CISS tank) to perform initial filling of the ink into the ink jet head. After the initial filling, nozzle check printing is performed, it is visually confirmed whether or not there is print misalignment or ejection failure, and determination is made based on the following criteria.

The print misalignment means a deviation of an ink landing position. The deviation of the landing position of 50% or more of the interval between adjacent nozzles as measured at a position 0.5 mm from the nozzles in the ejection direction is defined as the print misalignment.

Evaluation criteria
A: There is no print misalignment and no ejection failure.
B: Print misalignment occurs, but no ejection failure occurs.
C: Ejection failure occurs.

2. 5. Transfer resistance (duplex printing)

A modified machine of ink jet recording apparatus (EW-M634T, manufactured by Seiko Epson Corporation) equipped with a CISS tank is prepared, the main tank (CISS tank) is filled with the ink, and a black solid pattern is multilayer-printed on both sides of V-Paper (manufactured by FUJIFILM Corporation) at a resolution of 600 × 600 dpi in an environment of 10°C and 80% until a thickness of 1 cm is obtained. Printing is performed on both sides of A4 paper at 30 P/min and 15 sheets/min.

Whether or not there is a transfer mark of a reversing roller on an end portion of a paper surface after printing (the end face of the rear end portion in discharge after printing the opposite side) is visually confirmed, and determination is made based on the following criteria.

Evaluation criteria
A: No transfer mark of the roller is observed.
B: A transfer mark of the roller is slightly observed.
C: A transfer mark of the roller is clearly visible.

### 3. Evaluation Results

From the evaluation results of Tables 1 and 2, it is found that all of Examples 1 to 12 are excellent in the defoaming property, gas-liquid interface foreign matter suppression, redispersibility, initial filling property, and transfer resistance, as compared with Comparative Examples 1 and 5 containing no acetylene glycol-based surfactant, Comparative Examples 3 and 4 containing no water-soluble urethane resin, and Comparative Examples 2, 7, and 8 containing no 6- to 8-membered ring lactam.

What is claimed is:

1. A recording apparatus comprising:
an ink container; an ink supply path; an ink jet head; and an ink composition, wherein
the ink container includes an ink filling port through which the ink composition is poured,
the ink jet head receives a supply of the ink composition from the ink container through the ink supply path and ejects the ink composition, and
the ink composition is an aqueous ink containing a pigment, an acetylene glycol-based surfactant, a 6- to 8-membered ring lactam, a solvent containing water, and a water-soluble urethane resin dissolved in the solvent.

2. The recording apparatus according to claim 1, wherein
a content of the water-soluble urethane resin is 0.1% to 3.0% by mass with respect to a total amount of the ink composition.

3. The recording apparatus according to claim 1, wherein
a content of the lactam is 0.5% to 5.0% by mass with respect to a total amount of the ink composition.

4. The recording apparatus according to claim 1, wherein
the lactam includes ε-caprolactam.

5. The recording apparatus according to claim 1, wherein
a content of the acetylene glycol-based surfactant is 0.2% to 2.5% by mass with respect to a total amount of the ink composition.

6. The recording apparatus according to claim 1, wherein
the acetylene glycol-based surfactant includes an acetylene glycol-based surfactant having an HLB value of 6 or less.

7. The recording apparatus according to claim 1, wherein
the water-soluble urethane resin includes a water-soluble urethane resin having an acid number of 40 to 100 mg KOH/g.

8. The recording apparatus according to claim 1, wherein
a mass ratio A/B of a content A of the acetylene glycol-based surfactant to a content B of the lactam is 0.1 to 1.5.

9. The recording apparatus according to claim 1, wherein
the pigment includes a self-dispersing pigment.

10. The recording apparatus according to claim 1, further comprising
a betaine.

11. The recording apparatus according to claim 1,
which is used for recording on an absorptive recording medium.

12. A recording method using the recording apparatus according to claim 1, the method comprising:
a supplying step of supplying the ink composition poured into the ink container through the ink filling port from the ink container to the ink jet head through the ink supply path; and
an attaching step of attaching the ink composition to a recording medium by ejecting the ink composition from the ink jet head.
